(19) United States
(12) Patent Application Publication
(10) Pub. No.: US 2025/0315283 A1
(43) Pub. Date: Oct. 9, 2025

(54) ASSISTING A USER IN A MIXED REALITY EXPERIENCE USING GENERATIVE ARTIFICIAL INTELLIGENCE

(71) Applicant: simpleAR, Inc., Irvine, CA (US)

(72) Inventors: Julian Volyn, Long Valley, NJ (US); Michael Davis, Yorba Linda, CA (US); TJ Southard, Newport, NC (US); Phillip Do, Chandler, AZ (US); Josh Zavaleta, Aliso Viejo, CA (US); James Williams, Anaheim, CA (US); Marlo Brooke, Newport Coast, CA (US); Scott Toppel, Virginia Beach, VA (US)

(21) Appl. No.: 18/745,698

(22) Filed: Jun. 17, 2024

Related U.S. Application Data
(60) Provisional application No. 63/574,571, filed on Apr. 4, 2024.

(51) Int. Cl. G06F 9/451; G06T 19/00; G10L 15/26

(52) U.S. Cl. CPC G06F 9/453; G06T 19/006; G10L 15/26

(57) ABSTRACT

A facility for assisting a user in a mixed reality (MR) experience using generative artificial intelligence is disclosed. A user query and MR data associated with the MR experience is received and used to create a prompt to provide to a generative artificial intelligence (GAI) model. In some embodiments, the MR data includes source data, procedure data that is based on the source data and corresponds to a plurality of MR steps of the MR experience, and a current step indicator that corresponds to a current MR step that is being provided to the user. The facility provides the prompt to the AI model. Then, the facility creates content based on output of the AI model and causes the content to be provided to the user in the MR experience, such as by outputting it audibly to the user via simulated speech.

### CROSS-REFERENCE TO RELATED APPLICATIONS

This application claims the benefit of U.S. Provisional Application No. 63/574,571, filed Apr. 4, 2024, and entitled “ASSISTING AN END USER IN AN INSTRUCTIONAL GUIDE,” which is hereby incorporated by reference in its entirety.

This Application is related to U.S. patent application Ser. No. 18/584,751, filed Feb. 22, 2024, and entitled “GENERATING STRUCTURED DATA FOR MIXED REALITY APPLICATIONS USING GENERATIVE ARTIFICIAL INTELLIGENCE,” which is hereby incorporated by reference in its entirety. In cases where the present application conflicts with a document incorporated by reference, the present application controls.

### BACKGROUND

In a mixed reality experience, a user is presented with an environment wherein some objects in the environment are physically present with the user, and some objects are virtual objects. For example, a mixed reality experience showing a user how to replace a car's engine mounts may display a virtual car so that the car appears to the user to exist in the physical world. The mixed reality experience may be displayed to the user using a headset, a smart phone, etc.

### BRIEF DESCRIPTION OF THE DRAWINGS

FIG. 1 is a block diagram showing some of the components typically incorporated in at least some of the computer systems and other devices on which the facility operates.

FIG. 2 is a context diagram showing an environment used by the facility in some embodiments to use artificial intelligence to assist a user in a mixed reality experience.

FIG. 3 is a flow diagram showing a process used by the facility in some embodiments to assist a user in a mixed reality experience using artificial intelligence.

FIG. 4 is a data flow diagram that describes data exchange in accordance with some embodiments of the facility.

FIG. 5 is a flow diagram showing a process used by the facility in some embodiments to provide a generative artificial intelligence model with a hierarchy of information to be used in responding to the prompt.

### DETAILED DESCRIPTION

Modern computing and display technologies have facilitated the development of systems for mixed reality experiences, in which digitally reproduced images or portions thereof are presented to a user in a manner that simulates interaction with the physical world. A virtual reality, or “VR”, experience typically involves the presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, experience is a type of AR experience and typically involves virtual objects (artifacts) that are integrated into, and responsive to, the natural world. For example, in an MR experience, a virtual artifact may be occluded by real world objects and/or be perceived as interacting with other objects (virtual or real) in the real world. Throughout this disclosure, reference to AR, VR or MR is not limiting on the invention and the techniques may be applied to any context.

Mixed reality experiences can be used to guide a user through a procedure. For example, the user may be guided through each step in a procedure for changing a car's engine mounts. In this way, mixed reality applications convey procedural information in a more intuitive and immersive way than traditional techniques such as instruction manuals, instructional videos, etc. This makes mixed reality a desirable medium for providing procedural information.

Despite the immersive procedural content that can be provided by a mixed reality experience, a user in the mixed reality experience occasionally requires assistance. The user may have difficulty understanding how to perform a step in a mixed reality experience, encounter a bug or error, etc. For example, a user in a mixed reality experience that refers to a socket wrench while demonstrating how to change car engine mounts may not know what a socket wrench is. Thus, the user may not be able to continue the mixed reality experience without assistance. Traditional techniques for assisting users in mixed reality experiences often require the user to search for a solution online, contact user support, or otherwise leave the mixed reality experience. This may result in substantial waste of expensive mixed reality resources as the user disengages with the mixed reality experience and searches for assistance.

In response to recognizing these disadvantages, the inventors have conceived and reduced to practice a software and/or hardware facility for assisting a user in a mixed reality experience using generative artificial intelligence (“the facility”).

Innovations in machine learning technology have facilitated the development of generative artificial intelligence models including large language models (LLMs) such as generative pre-trained transformer (GPT)-3 and GPT-4, generative adversarial networks, recurrent neural networks, reinforcement learning models, variational autoencoders, etc. In general, a generative artificial intelligence model is trained to generate content in response to a prompt.

LLMs like GPT-4 operate on natural language and may be capable of generating output responsive to a variety of prompts, including prompts specifying a format for the output to follow. For example, an LLM may take as input a natural language prompt such as “write a haiku about birds.” The LLM then produces as output a natural language haiku about birds. Furthermore, LLMs or other artificial intelligence models may be used to perform speech-to-text or text-to-speech, such that a human may communicate with an LLM using spoken language. For example, speech from a user is received, converted into text, and provided to the LLM. Then, the LLM generates text that is converted into speech and provided to the user.

Generative artificial intelligence models may be trained, queried, or both, using multimodal data and are not necessarily limited to generating output text in response to a text-based prompt. For example, Sora is a generative artificial intelligence model that generates video based on text-based prompts. Various generative artificial intelligence models generate output data of various modes such as text, video, still images, etc. in response to prompts containing data of various modes. In various embodiments, the prompt provided to the generative artificial intelligence model to answer a user query includes text, video, audio, still images, etc., or any combination thereof.

A prompt to an LLM may specify various parameters for the LLM to follow in generating its response to the prompt. For example, when the prompt requests that the LLM provide its answer in a specified JavaScript Object Notation (JSON) format, the LLM will provide its answer in the specified JSON format. The ability of LLMS to generate structured data enables LLM responses to be integrated into various dataflows.

When a user has a question during their participation in a mixed reality experience, they can pose the question as a user query, such as by speaking the question. The facility receives the user query and creates a prompt to provide to a generative artificial intelligence (GAI) model based on the user query and mixed reality (MR) data associated with an MR experience being displayed to the user, such as MR data that includes procedure data that corresponds to a plurality of MR steps of the MR experience. In some embodiments, the MR data includes source data from which the procedure data is derived and a current step indicator that corresponds to a current MR step that is being provided to the user. The facility provides the prompt to the AI model. Then, the facility creates content based on output of the AI model and causes the content to be provided to the user in the MR experience, such as by outputting it audibly to the user via simulated speech.

By performing in some or all of the ways described above, the facility assists a user in a mixed reality experience using artificial intelligence. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, the facility may conserver computing resources such as processor cycles or network bandwidth that may otherwise be dedicated to supporting a user manually searching for assistance with the MR experience. Furthermore, the facility may conserve computing resources used to display the MR experience because the user does not leave the MR experience running for long periods of time as the user searches for assistance. This reduces the amount of time the facility displays the MR experience, conserving computing resources.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, a human mind cannot provide a mixed reality experience, nor automatically respond to queries about the mixed reality experience using information corresponding to the mixed reality experience.

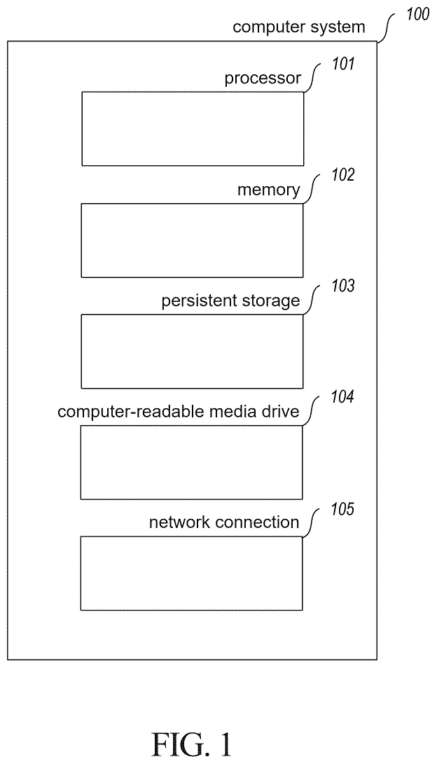

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

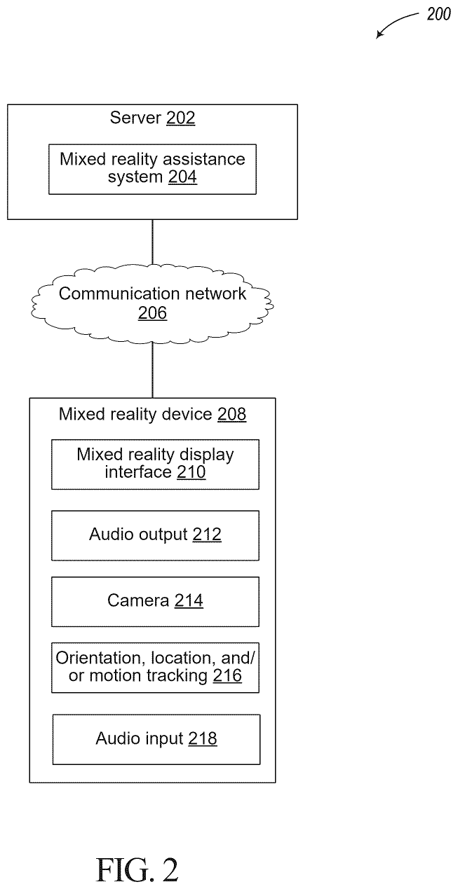

FIG. 2 is a context diagram showing an environment 200 used by the facility in some embodiments to use artificial intelligence to assist a user in a mixed reality experience. Environment 200 includes server 202, mixed reality device 208, and communication network 206.

In various embodiments, server 202 and mixed reality device 208 communicate with each other via communication network 206. Communication network 206 includes one or more wired or wireless networks.

Mixed reality device 208 provides a mixed reality experience to a user using mixed reality display interface 210 to present visual information. Audio of the mixed reality experience may be provided using audio output 212. In a mixed reality experience, virtual objects are often displayed to the user so they appear to persist at a location in physical space. For example, when a virtual internal combustion engine is displayed to a user as resting on a table, when the user turns around to retrieve tools, the virtual internal combustion engine continues to be displayed as resting on the table. An orientation, location, and/or motion of mixed reality device 208 may be tracked such that virtual objects may be displayed consistently with respect to the physical world. Orientation, location, and/or motion tracking 216 may include one or more inertial measurement units that include one or more gyroscopes, accelerometers, magnetometers, radio receivers or light sensors being signaled by stationary beacons, etc., or any combination thereof.

Orientation may also be tracked by tracking one or more anchors using camera 214. An anchor is an expected feature in an environment that the mixed reality device 208 detects and tracks to ensure that virtual artifacts in the mixed reality experience appear to a viewer of the mixed reality experience to remain at a consistent position and orientation in space. In various embodiments, the anchor is an image anchor, an object anchor, a geo anchor, a location anchor, an auto anchor, etc. An image anchor includes a single predefined image or Quick Response (QR) code to be detected. An object anchor includes a reference model to be detected. A geo anchor includes a GPS location to be detected, while a location anchor includes one or more features in a physical environment to be detected.

While mixed reality assistance system 204 is shown in FIG. 2 as implemented using server 202, the disclosure is not so limited. In some embodiments, mixed reality assistance system 204 is implemented using mixed reality device 208.

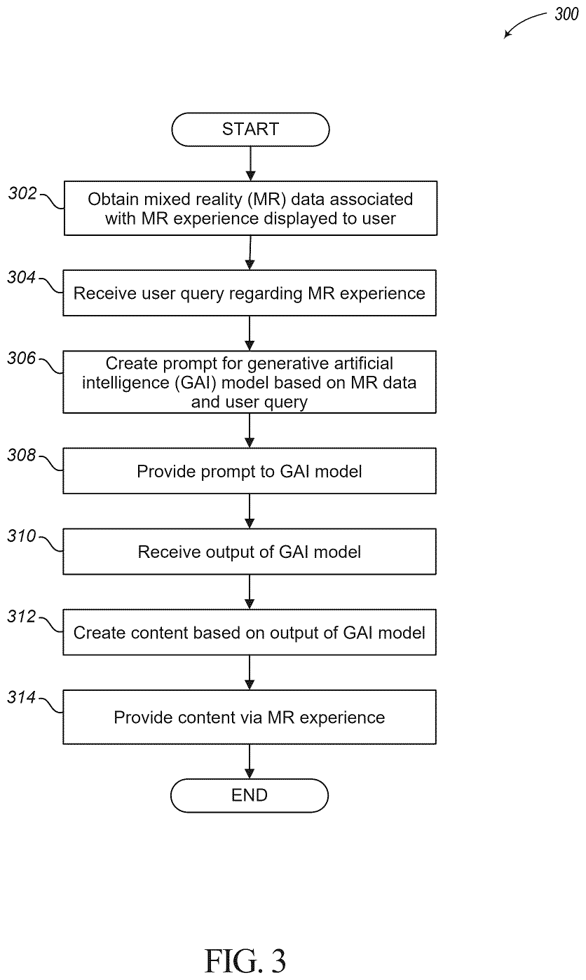

FIG. 3 is a flow diagram showing a process 300 used by the facility in some embodiments to use artificial intelligence to assist a user in a mixed reality experience.

Process 300 begins, after a start block, at block 302, where the facility obtains mixed reality (MR) data associated with an MR experience displayed to a user. In various embodiments, the MR data includes one or more source documents or portions thereof, source data, procedure data, a current step indicator, or any combination thereof. The one or more source documents may include manuals or other instructional content relating to the MR experience. The source data includes unstructured or semi-structured text relating to the MR experience that may be derived from the one or more source documents. The procedure data includes structured data defining MR steps in the MR experience. The current step indicator may indicate an MR step in the MR experience currently being displayed to the user. Creating a mixed reality experience having one or more steps based on one or more source documents or portions thereof is described in detail in U.S. patent application Ser. No. 18/584,751, filed Feb. 22, 2024, and entitled “GENERATING STRUCTURED DATA FOR MIXED REALITY APPLICATIONS USING GENERATIVE ARTIFICIAL INTELLIGENCE.”

In some embodiments, source documents relating to an MR experience to be generated procedure may be used to create the MR experience. For example, when an MR procedure in the MR experience involves replacing engine mounts of a car, various source documents such as an owner's manual, workshop manual, service manual, online forum or social media posts, etc. may include descriptions of how to replace the engine mounts. In some embodiments, one or more source documents may be converted to text to be used in creating the MR experience, creating a prompt for user assistance in the MR experience, or both.

Table 1 below depicts an excerpted example of source data for an MR experience that includes an MR procedure for replacing a car's engine mounts. In the example shown in Table 1, the source data was generated by converting a manual describing replacement of the car engine mounts into text.

TABLE 1
excerpted example source data for replacing car engine mounts

01/28/2024The present document was valid at the time of print. A later version may
be available online.WM, 103519 Removing and installing engine mounts (V6
Turbo)Tool denominationTypeTool numberImagesupport bracketVW tool□10-
222Asocket-wrench insert 39-piece socketsetVehicle-specificworkshopequip-
ment□VAS 6928ratchet wrench, a/f 13VW tool□T10384LocationDes...TypeBasic
val...Toleranc...Toleranc...Engine mounting bolts on frontaxle carrierM10 x
55Torque55 Nm (40.6ftlb.)Bolt, engine mounting to frontaxleM8 x 50Torque30 Nm
(22.1ftlb.)Bolts, engine mounting to enginecarrierInitial tightening90 Nm
(66.4ftlb.)Bolts, engine mounting to enginecarrierFinal tightening+ 90 °Screw for oil
guide housingholderM6 x 16Tightening torque8 (6 ftlb.) NmEarth line on engine
carrierItem 1Tightening torque20 Nm (14.8ftlb.)Line bracket fastening screw
onfront axle carrierItem 2Tightening torque8 Nm (5.9 ftlb.)Installation
positionInstallation positionPreliminary workTools□Technical
values□4507531alujFeb 2, 20244507531alujFeb 2, 20244507531alujFeb 2,
20244507531alujFeb 2,
2024C:/Users/User/AppData/LocalLow/simplear/ARcreate//Porsche Service WM
103519 Removing and installing engine mounts (V6
Turbo).pdf//images//image_1_1.png
C:/Users/User/AppData/LocalLow/simplear/Arcreate//Porsche Service WM 103519
Removing and installing engine mounts (V6 Turbo).pdf//images//image_1_2.png
C:/Users/User/AppData/LocalLow/simplear/Arcreate//Porsche Service WM 103519
Removing and installing engine mounts (V6 Turbo).pdf//images//image_1_3.png
C:/Users/User/AppData/LocalLow/simplear/Arcreate//Porsche Service WM 103519
Removing and installing engine mounts (V6 Turbo).pdf//images//image_1_4.png
Preliminary work for left engine mounting1Support the engine on the body.2On
vehicles with PDCC:Remove front-axle support.3Remove wheel housing liner
front.4Remove engine mount (supporting mount).5Detach air-conditioning
compressor and tie it up, but do not open the refrigerant system.Preliminary work
for right engine mount1Support the engine on the body.2On vehicles with
PDCC:Remove front-axle support.3Remove front wheel housing liner.4On non-
hybrid vehicles:Remove the generator.

As shown in Table 1, in some embodiments the source data references embedded multimedia content such as “image_1_1.png,” but includes text-based file paths corresponding to the embedded multimedia content rather than the embedded multimedia content itself. In some embodiments, multimedia source documents such as portable document formats (“PDFs”) are converted into text-only source data that the facility uses to create the prompt for assistance, the procedure data, or both. In various embodiments, the source data is created using any number of source documents. For example, multiple manuals, instructions, etc., or portions thereof may be combined to create the source data.

The procedure data defines one or more steps in the MR procedure. In some embodiments, the procedure data is automatically generated based on the source data. In some embodiments, the facility provides the source data to a generative artificial intelligence model with a command for the generative artificial intelligence model to produce the procedure data from the source data. Automatically generating procedure data for mixed reality applications based on source data is described in detail in U.S. patent application Ser. No. 18/584,751, filed Feb. 22, 2024, and entitled “GENERATING STRUCTURED DATA FOR MIXED REALITY APPLICATIONS USING GENERATIVE ARTIFICIAL INTELLIGENCE.” An example of procedure data automatically generated from the source data shown in Table 1 is shown in Table 2.

TABLE 2
excerpted example procedure data for replacing car engine mounts

“{“procedure_name”:“Removing left engine mounting”,“summary”:“This procedure
explains how to remove the left engine
mounting.”,“instructions”:[{“number”:1,“instruction”:“Disconnect the electric wiring
harness.”,“image_file”:null},{“number”:2,“instruction”:“Remove the engine
mount.”,“image_file”:null}],“queueForConversion”:true,“sourceDataPath”:null}”

As illustrated in Table 2, the procedure data includes structured data defining steps in an MR procedure to be provided to a user via the MR experience. For example, step 1 in the MR procedure illustrated in Table 2 includes instructions to “disconnect the electric wiring harness,” and an indication that there is no image file corresponding to step 1.

In some embodiments, the MR procedure or a portion thereof is not automatically generated. In some embodiments, the MR procedure is created based on steps enumerated by an operator such as an auto technician instead of being automatically generated based on a source document. In some embodiments, therefore, source documents, source data, or both, is not available for the mixed reality experience because the procedure data was manually created.

The current step indicator indicates a step in the procedure data that corresponds to what is currently being displayed to the user in the MR experience. For example, when the facility is currently displaying a second step of an MR procedure to a user, the current step indicator indicates that the user is currently being displayed the second step in the MR procedure.

In some embodiments, the MR data includes additional information from the source document. The source document may include additional information not in the source data. For example, when the source document is a PDF that includes various images, tables, etc., the source data may only include text, as depicted in Table 1.

In some embodiments, the MR data includes additional background information regarding the MR experience. For example, the background information may include instructional video transcripts, online forum or social media posts, etc. relating to the MR experience or a procedure related to the MR experience.

In some embodiments, the MR data includes information associated with a user to whom the mixed reality experience is being displayed, such as questions the user previously asked the mixed reality assistance system, a level of experience of the user with respect to the mixed reality experience, an MR step to be performed in the mixed reality experience, equipment or techniques used in the MR experience, etc. The level of experience may be a number of years of experience the user has in a relevant area such as auto maintenance, welding, electrical work, heavy machinery operation, etc., a number of past MR experiences displayed to the user that include similar MR steps, tools, techniques, etc. For example, the user may be an experienced auto mechanic who requires a small amount of detailed information specific to replacing engine mounts in a particular year, make, or model of vehicle. The user may also have little or no experience relevant to the MR experience and require more comprehensive or general information regarding the MR experience. The information associated with the user may be used to create a prompt to request assistance from the GAI model, as discussed herein.

In some embodiments, the facility causes the MR experience to display a request for information from the user regarding one or more relevant levels of experience. In some embodiments, the facility obtains stored information associated with the user, such as from a user profile stored using server 202 of FIG. 2. In some embodiments, the facility obtains information associated with the user via a public or private online social media profile, employee directory, etc.

In some embodiments, a portion of the MR data is obtained from server 202 or another computing device, and a portion of the MR data is obtained from MR device 208. After block 302, process 300 continues to block 304.

At block 304, the facility receives a user query regarding the MR experience. In some embodiments, the user provides the user query through speech. For example, the user may verbally ask: “What is the next step in the procedure?”; “What tools do I need to remove the engine mount?”; “What's a socket wrench?”; etc. In some such embodiments, the user query is converted from speech into text to be provided to the generative artificial intelligence model. After block 304, process 300 continues to block 306.

At block 306, the facility creates a prompt for a generative artificial intelligence model based on the MR data and the user query. The prompt is created to obtain an answer to the user query using the GAI model.

In some embodiments, the facility creates the prompt by transforming the user query and the MR data into structured data that conforms to a specified format. The prompt may be created based on the structured data and a description of the specified format. For example, one or more of the user query, the source data, the procedure data, or the current step indicator may be transformed into a JavaScript Object Notation (JSON) format, which is included in the prompt. In some embodiments, the facility includes a description of the specified format. For example, the prompt may include one or more of the commands shown in Table 3.

TABLE 3
example prompt commands

You are a helpful assistant. Answer as succinctly as possible in less than 3 sentences if
possible. The user will send their question and any source or procedural data in the
following JSON format while they execute a step by step procedure.

| | |
|---|---|
| { | userMessage: The question to answer from the user |
| | sourceData: Any source data to help address the question will be sent here |
| | procedureData : Any procedural data in a JSON format will be sent here |
| | currentStep : This represents the step the user is currently in from the |

procedureData
}
You should check if there is any relevant source and or procedure data sent when
answering your question. If there is none, please let the user know how you came
to your answer.

As illustrated in Table 3, the prompt may include information describing a format of the prompt, contents of the prompt, etc. For example, the prompt may describe one or more of the user query, the source data, the procedure data, the current step, or any combination thereof. Including information describing the prompt may assist the GAI model to interpret the prompt accurately.

A generative artificial intelligence model is typically pretrained on large volumes of data to enable it to generate output that is responsive to a prompt. Thus, a GAI model may be capable of providing some information about various MR procedures based on its pretraining. For example, when the user query is “What is a socket wrench?”, the GAI model may respond with a description a socket wrench based on its pretraining.

However, the GAI model's pretraining may be insufficient to answer MR experience-specific questions. For example, when the user query is “What is the next step of the procedure?”, the user is referring to context-specific information that the GAI model is unlikely to answer accurately based on its pretraining alone. In some embodiments, the prompt therefore includes information specific to the MR experience such as source data or procedure data that enables the GAI model to better answer context-specific questions.

In some embodiments, the prompt includes an indication of how the generative artificial intelligence is to prioritize various sources of information when generating a response to the prompt. For example, Table 3 illustrates example prompt commands that include “You should check if there is any relevant source and or procedure data sent when answering your question.”

In some embodiments, the prompt includes information associated with the user such as a level of experience relevant to the MR experience. For example, the prompt may include various positions or certifications held by the user, information regarding past MR experiences displayed to the user, self-reported levels of experience of the user, etc. The information associated with the user may be included in the prompt with a command instructing the GAI model to tailor its response to be appropriate to a user having the user's level of experience. Thus, the GAI model may respond to queries from experienced users differently from inexperienced users, for example.

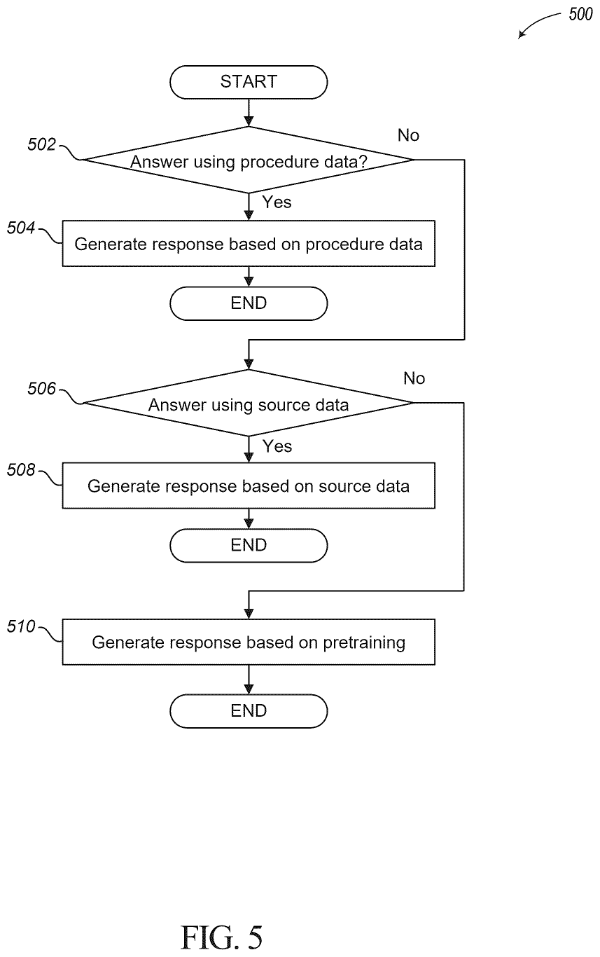

In various embodiments, the prompt includes a command instructing the GAI model to preferentially generate an answer using information from the source data, the procedure data, or any other source of information. Constructing the prompt to indicate that the GAI model is to prioritize various sources of information is described in detail with respect to FIG. 5.

In various embodiments, the GAI is a large language model (LLM). LLMs often generate output based on next-token prediction. For example, when provided with one or more words such as “detach air-conditioning,” an LLM may generate candidate words based on its pretraining or information provided via the prompt. For example, the LLM may determine that a next token after “detach air-conditioning” may be “compressor” with a probability of 60%, “hose” with a probability of 30%, “unit” with a probability of 5%, etc.

In various embodiments, the facility creates the prompt to specify one or more parameters for the GAI model to use in responding to the prompt. For example, the facility may include a temperature parameter for the GAI model to use in generating its response.

At a relatively low temperature, the GAI more often selects tokens with high probability. For example, at minimum temperature the GAI may always select the token with the highest probability. Thus, when provided with the phrase “detach air-conditioning”, the GAI may select the term “compressor” at low temperature because “compressor” is the most likely next token. As a result, a low-temperature GAI model may produce output that replicates or closely follows training data or data included in the prompt. At a low temperature such as 0% of maximum temperature, the GAI model prompted to summarize a sentence provided in a prompt may repeat the sentence largely verbatim in its response, because the highest probability tokens may be words appearing in the sentence. For example, when prompted with an excerpt from Table 1 such as: “Detach air-conditioning compressor and tie it up, but do not open the refrigerant system” and a command to summarize the sentence using a relatively low temperature such as 0%-20% of the maximum temperature, the GAI model may respond: “Detach the air-conditioning compressor and secure it, ensuring the refrigerant system remains closed.”

At a relatively high temperature such as 80%-100% of the maximum temperature, the GAI model selects lower-probability tokens, producing output that may vary more substantially from training data or data provided in the prompt. For example, when prompted to summarize the sentence “Detach air-conditioning compressor and tie it up, but do not open the refrigerant system” using 100% temperature, the GAI model may respond: “Remove the air-conditioning compressor and fasten it securely, making sure not to disturb the refrigerant system by leaving it closed.” Increasing the temperature of the GAI model therefore causes the GAI model to produce lower-probability outputs.

In some embodiments, the facility automatically selects a temperature to be used based on the prompt. When the prompt involves an industrial application, military application, etc. the facility may include a command in the prompt for the GAI model to use a relatively low temperature to avoid providing the user with inaccurate information regarding the mixed reality experience. In some embodiments wherein the prompt involves a safe consumer product, for example, the facility specifies a relatively high temperature for the GAI model to use such that the GAI model provides information that is less directly related to the prompt but may include additional related information. This may allow the GAI model to elaborate on data provided in the prompt, provide alternative explanations, etc. In some embodiments, the facility includes a command in the prompt instructing the GAI model to select a temperature to use for its response based on a level of risk in the procedure to a human, equipment, environment, etc. as determined by the GAI model or provided in the prompt.

In some embodiments, an operator specifies a temperature or range of temperatures to be used with respect to a selected mixed reality experience. The facility uses the temperature or range of temperatures to generate prompts with respect to subsequent instances of the mixed reality experiences. For example, when the operator specifies a temperature range, such as 50% to 70% of the maximum temperature value, the facility in some embodiments automatically selects a temperature from the specified range based on the prompt.

In some embodiments, the facility specifies a Top-P value for the GAI model to use in responding to the prompt. Top-P may refer to a minimum probability of a next token provided by the GAI model. For example, a Top-P value of 0.9 or 90% indicates that the GAI model selects a next token from a group of the most likely tokens having cumulative probability above 90%.

In various embodiments, the facility constructs the prompt to instruct the GAI model to use a specified value for any hyperparameter such as a Top-K value, a repetition penalty, a stopping criteria, etc. After block 306, process 300 continues to block 308.

At block 308, the facility provides the prompt to the GAI model. In some embodiments, the facility provides the prompt to the GAI model implemented using the MR device. In some embodiments, the facility provides the prompt to the GAI model using an application programming interface of the GAI model. After block 308, process 300 proceeds to block 310.

At block 310, the facility receives output of the GAI model. After block 310, process 300 continues to block 312.

At block 312, the facility creates content based on the output of the GAI model. In some embodiments, the facility creates the content by transforming text-based output of the GAI model into synthesized speech. In some embodiments, the facility generates the synthesized speech by providing the output of the GAI model to a text-to-speech service such as Amazon Polly®, Azure® text to speech, etc. In some embodiments, the facility generates the synthesized speech by providing the output of the GAI model to a special-purpose computer configured to perform text-to-speech such as a field programmable gated array (FPGA), application-specific integrated circuit (ASIC), etc. In some embodiments, the facility generates the synthesized speech using a neural network deployed, for example, using server 202 or mixed reality device 208 of FIG. 2. After block 312, process 300 continues to block 314.

In some embodiments, the facility determines a format of the created content based on capabilities or settings of the mixed reality device. For example, in response to determining that the mixed reality device does not have audio output or the audio output is turned off, the content may be formatted to be provided visually.

At block 314, the facility provides the content to the user via the MR experience. The format in which the facility provides the content to the user may vary based on the content. For example, audio-based content may be provided using audio output 212 of mixed reality device 208 in FIG. 2. Text-based content may be provided using mixed reality display interface 210 of mixed reality device 208 in FIG. 2.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

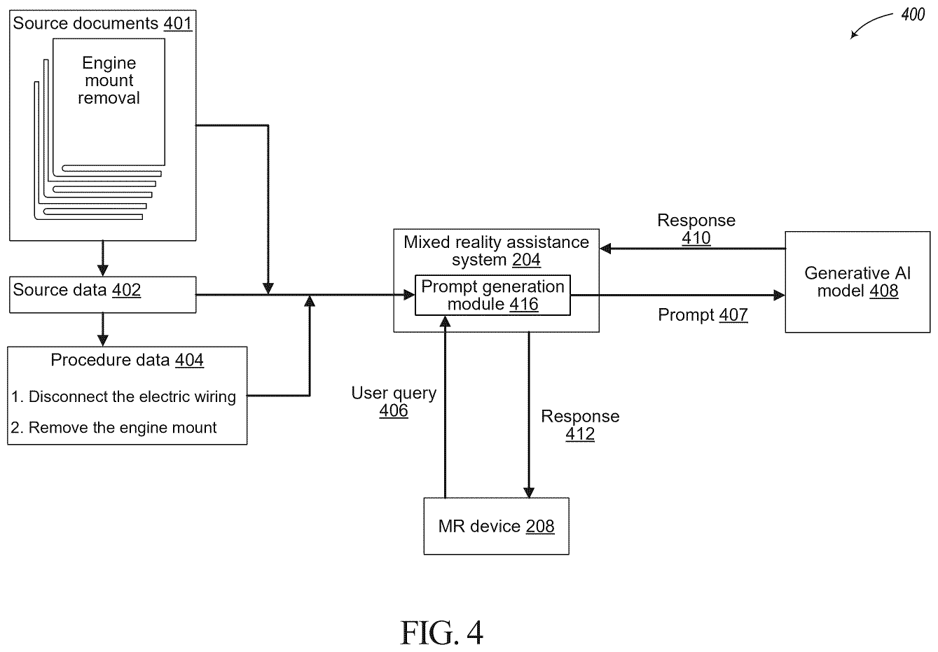

FIG. 4 is a data flow diagram that describes data exchange 400 in accordance with some embodiments of the facility. Source documents 401 include various information relating to a mixed reality procedure the user is experiencing. In some embodiments, source documents 401 include instructional manuals or other content. In some embodiments, source data 402 is generated using source documents 401. In some embodiments, procedure data 404 is generated using source data 402. In some embodiments, procedure data 404 is generated directly from the source documents 401.

Mixed reality assistance system 204 includes prompt generation module 416, which may obtain source documents 401, source data 402, procedure data 404, or any combination thereof. Prompt generation module 416 receives user query 406 via MR device 208, which includes a user query about the MR experience being displayed to the user using MR device 208. Prompt generation module 416 creates prompt 407 to provide to generative AI model 408 based on the user query 406 and source documents 401, source data 402, procedure data 404, or a combination thereof. In some embodiments, the facility uses additional sources of information to create prompt 407, such as information associated with the user.

Generative AI model 408 receives prompt 407 and generates response 410, which is provided to mixed reality assistance system 204. In some embodiments, mixed reality assistance system 204 modifies response 410, such as by converting text in response 410 to synthesized speech, to produce response 412, which is provided to MR device 208 to present content to the user. In some embodiments, MR device 208 applies one or more transformations to response 412 to produce the content to present to the user, such as converting response 412 into synthesized speech.

In various embodiments, mixed reality assistance system 204, generative AI model 408, or both, are implemented using MR device 208. One or more of source documents 501, source data 402, or procedure data 404 may be stored using MR device 208.

FIG. 5 is a flow diagram showing a process 500 used by the facility in some embodiments to provide the GAI with a hierarchy of information to be used in responding to the prompt. In some embodiments, the facility constructs the prompt to include a command instructing the GAI model to respond to the prompt based on the procedure data and, if it cannot, to respond based on the source data.

Process 500 begins, after a start block, at block 502, where the facility determines whether the user query may be answered using the procedure data. When the facility determines yes, process 500 continues to block 504. When the facility determines no, process 500 continues to block 506.

At block 504, the facility generates a response based on the procedure data. After block 504, process 500 ends at an end block.

At block 506, the facility determines whether the user query may be answered using the source data. When the facility determines yes, process 500 continues to block 508. When the facility determines no, process 500 continues to block 510.

At block 508, the facility generates a response based on the source data. After block 508, process 500 ends at an end block.

At block 510, the facility generates a response based on the generative artificial intelligence model's pretraining. After block 514, process 500 ends at an end block.

In various embodiments, the facility implements process 500 using one or more commands in the prompt to be provided to the GAI. For example, the facility may construct the prompt to include one or more commands such as: “Please generate your response based on the procedure data if possible. If it is not possible to generate your response based on the procedure data, please generate your response based on the source data. If it is not possible to generate your response based on the source data, please generate your response based on your pretraining.” By instructing the GAI to prioritize information that may be more relevant, the facility increases the quality or relevance of information provided in the response. For example, the facility may prevent the GAI from using less relevant data acquired during pretraining to answer a question that may be answered using highly relevant data in the procedure data or the source data.

While FIG. 5 reflects a prompt that instructs the GAI model to respond using procedure data, then source data, then pretraining data, the disclosure is not so limited. In various embodiments, the prompt may be created to instruct the GAI model to preferentially use any accessible source of information. For example, the prompt may instruct the GAI model to preferentially respond based on specific information in the source data or the procedure data, such as images in the source data. The facility may specify any hierarchy of preference for sources of information.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
obtaining mixed reality (MR) data associated with an MR experience being displayed to a user, wherein the MR data includes:
source data that includes instructional content;
procedure data that is based on the source data and corresponds to a plurality of MR steps of the MR experience;
a current step indicator that corresponds to a current MR step of the plurality of MR steps that is being provided to the user;
receiving a user query regarding the MR experience via an MR device that is displaying the MR experience to the user;
creating a prompt to provide to a generative artificial intelligence (GAI) model, wherein the prompt is based on:
the user query,
the MR data, and
an indication that the GAI model is to respond to the user query using the MR data;
providing the prompt to the GAI model;
receiving output of the GAI model in response to the prompt;
creating content based on the received output of the GAI model; and
causing the MR device to provide the content to the user via the MR experience.

2. The method of claim 1, wherein creating the prompt comprises:
transforming the user query and the MR data into structured data that conforms to a specified format; and
creating the prompt based on the structured data and a description of the specified format.

3. The method of claim 1, wherein creating the content based on the output of the GAI model comprises:
generating an audio component of the content by applying text-to-speech to the output of the AI model,
and wherein causing the MR device to provide the content comprises audibly rendering the audio component to the user.

4. The method of claim 1, wherein receiving the user query comprises receiving audio captured from the user,
and wherein creating the prompt comprises generating a text component of the query text by applying speech-to-text to the audio of the user query.

5. The method of claim 1, wherein receiving the user query comprises:
receiving the user query that includes a request for information regarding an MR step in the plurality of MR steps that is different from the current MR step.

6. The method of claim 1, further comprising:
generating the procedure data by providing the source data to the GAI model with one or more commands indicating that the GAI model is to extract the procedure data from the source data.

7. The method of claim 1, wherein obtaining the MR data comprises:
generating procedure data that corresponds to a first MR step of the plurality of MR steps based on the source data using the GAI model; and
obtaining procedure data corresponding to a second MR step of the plurality of MR steps based on user input.

8. The method of claim 1, wherein procedure data corresponding to an MR step of the plurality of MR steps is created by:
receiving output of the GAI model produced in response to a prompt that is based on the source data;
receiving user input that modifies the output of the GAI model; and
creating the procedure data corresponding to the MR step based on the output of the GAI model and the user input.

9. The method of claim 1, wherein creating the prompt comprises:
identifying related content using the source data;
obtaining the identified related content; and
creating the prompt based on the related content.

10. The method of claim 1, wherein the creating the prompt comprises:
including a hyperparameter command that specifies a temperature parameter between 40% and 60% of a maximum temperature value or a top-p parameter between 90% and 100% of a maximum top-p value to be used by the GAI model in generating the content.

11. The method of claim 1, wherein creating the prompt comprises:
creating the prompt to include a command that indicates that the GAI model is to answer the user query based on general knowledge acquired in training the base GAI model in response to the GAI model detecting that a probability corresponding to one or more output tokens produced by the GAI model using the MR data is below a confidence threshold.

12. The method of claim 1, wherein the MR data includes multimedia content distinct from the source data.

13. The method of claim 1, wherein creating the content comprises using the output of the AI model to produce audio content using text-to-speech.

14. The method of claim 1, wherein the GAI model is a large language model (LLM).

15. A system comprising:
one or more memories configured to collectively store instructions; and
one or more processors configured to collectively execute the instructions to perform actions, the actions comprising:
displaying a mixed reality (MR) experience to a user;
obtaining mixed reality data associated with the MR experience being displayed to the user, wherein the MR data includes:
procedure data that corresponds to a plurality of MR steps of the MR experience; and
a current step indicator that corresponds to a current MR step of the plurality of MR steps that is being provided to the user; and
receiving a user query regarding the MR experience;
creating a prompt to provide to a generative artificial intelligence (GAI) model, wherein the prompt is based on:
the user query,
the MR data, and
an indication that the GAI model is to respond to the user query using the MR data;
providing the prompt to the GAI model;
receiving output of the GAI model in response to the prompt;
creating content based on the output of the GAI model; and
providing the content to the user via the MR experience.

16. The system of claim 15, wherein creating the prompt comprises:
creating the prompt using source data that was not used to create the procedure data.

17. The system of claim 15, wherein the GAI model is implemented using the one or more processors.

18. One or more memories collectively storing instructions that, when executed by one or more processors in a computing system, cause the one or more processors to perform actions, the actions comprising:
obtaining mixed reality (MR) data associated with an MR experience being displayed to a user, wherein the MR data includes:
source data that includes instructional content;
procedure data that corresponds to a plurality of MR steps of the MR experience;
a current step indicator that corresponds to a current MR step of the plurality of MR steps that is being provided to the user;
receiving a user query regarding the MR experience;
creating a prompt to provide to a generative artificial intelligence (GAI) model, wherein the prompt is based on:
the user query,
the MR data, and
an indication that the GAI model is to respond to the user query with content that it generates using the MR data;
providing the prompt to the GAI model;
receiving, via the GAI model, the content in response to the prompt; and
causing the MR device to provide the content to the user via the MR experience.

19. The one or more memories of claim 18, wherein the MR data includes multimedia content distinct from the source data.

20. The one or more memories of claim 18, wherein creating the prompt comprises:
transforming the user query and the MR data into structured data that conforms to a specified format; and
creating the prompt based on the structured data and information that describes the specified format.
